(19) United States
(12) Patent Application Publication
(10) Pub. No.: US 2012/0257206 A1
(43) Pub. Date: Oct. 11, 2012

(54) OPTICAL DELAY-LINE INTERFEROMETER FOR DPSK AND DQPSK RECEIVERS FOR FIBER-OPTIC COMMUNICATION SYSTEMS

(76) Inventors: Ruibo Wang, Oak Park, CA (US); Pawei Menzfeld, Camarillo, CA (US); Yudong Li, Thousands Oaks, CA (US)

(21) Appl. No.: 13/442,744

(22) Filed: Apr. 9, 2012

Related U.S. Application Data
(60) Provisional application No. 61/516,698, filed on Apr. 7, 2011.

(51) Int. Cl. G01B 9/02

(52) U.S. Cl. 356/450

(57) ABSTRACT

Some example embodiments of an interferometer for fiber optic communication systems include a pair of identical beam splitting prisms. Each of the beam splitting prisms includes a first total-internal-reflection surface, a second total-internal-reflection surface parallel to the first total-internal-reflection surface, and a beam splitting interface parallel to the first total-internal-reflection surface. An interferometer embodiment may optionally include a thermo-optic compensator disposed between the two beam splitting prisms. A beam splitting plate may optionally be included in some example embodiments to provide four spatially-separated output ports, two from each of two delay line interferometers sharing the two beam-splitting prisms. An alternative embodiment of an interferometer includes a beam splitting prism, a retro-reflective prism, and a beam splitting plate arranged to have four output ports spatially separated from one another, two of each port associated with a different one of two delay line interferometers sharing the beam splitting and retro-reflective prisms.

### CROSS REFERENCE

This application claims priority to U.S. Provisional Application No. 61/516,698 filed Apr. 7, 2011, titled “Optical Delay-Line Interferometer for DPSK and DQPSK Receivers for Use in Fiber-Optic Communication Systems”, incorporated herein by reference in its entirety.

### FIELD OF THE INVENTION

Embodiments of the invention are related generally to optical interferometers and more specifically to Mach-Zehnder interferometers for modulating and demodulating optical signals in fiber optic communication systems.

### BACKGROUND

Phase Shift Keying (PSK) is a signal modulation technology having advantages over intensity modulation technology in the aspects of dispersion and nonlinearity tolerance. PSK is a modulation scheme that communicates digital data by modulating the phase of a reference signal sent between source and destination transponders. In PSK, a phase value corresponds to a unique pattern of binary digits which may be referred to as a symbol. Differential Phase Shift Keying (DPSK) reduces ambiguity caused by phase shifts added by the communication channel through which phase modulated signals are transmitted. In DPSK, the phase between two successive symbols transmitted from a source is compared at the destination and the difference in phase between the symbols is used to determine the digital data originally transmitted from the source. The relative phase shift between two adjacent symbols may be extracted before the detectors at the destination. A differential quadrature phase-shifted keying signal (DQPSK) may use four phase differences to encode two bits per symbol with two DPSK delay-line interferometers.

Phase extraction may be performed with a demodulator implemented with a delay-line interferometer. In a delay-line interferometer, the time delay difference for light travel in the interferometer's two interference arms may equal the period (i.e., the time duration) of one bit. The interferometer compares the phase of two sequential bits, and converts the phase keyed signal into amplitude keyed signal.

Examples of delay-line interferometers include Michelson interferometers, Mach-Zehnder interferometers, and polarization interferometers. Each of these interferometers may have a first beam splitter for dividing an input light beam into two light paths. A second beam splitter recombines the light beams from the two light paths and redirects the light beams through two arms into two output ports. For a particular value of bit rate, the time delay between the light signals passing through the two arms depends on the precise difference in optical path lengths. By adjusting the path length difference to match the phase shift modulated at the transmission side, phase encoded signals can be converted into intensity encoded signals.

One delay-line interferometer may be used to decode a stream of DPSK encoded signals. For optical communication systems using an n-phase-shifted keying modulation scheme, up to n number of delay line interferometers may be required.

### SUMMARY

Some example embodiments of an interferometer for fiber optic communication systems include a pair of identical beam splitting prisms. Each of the beam splitting prisms includes a first total-internal-reflection surface, a second total-internal-reflection surface parallel to said first total-internal-reflection surface, and a beam splitting interface parallel to said first total-internal-reflection surface. The example embodiment of an interferometer further includes a thermo-optic compensator disposed between said first and second beam splitting prisms. A beam splitting plate may optionally be included in some example embodiments to provide four spatially-separated output ports, two from each of two delay line interferometers sharing the two beam-splitting prisms.

Another example embodiment of an interferometer includes a beam splitting prism, a retro-reflective prism, and a beam splitting plate arranged to have four output ports spatially separated from one another, two of each port associated with a different one of two delay line interferometers sharing the beam splitting and retro-reflective prisms. The beam splitting prism includes a first total-internal-reflection surface, a second total-internal-reflection surface parallel to said first total-internal-reflection surface, and a beam splitting interface parallel to said first total-internal-reflection surface.

This section summarizes some features of the present embodiment. These and other features, aspects, and advantages of the embodiments of the invention will become better understood with regard to the following description and upon reference to the following drawings.

### BRIEF DESCRIPTION OF THE DRAWINGS

FIG. 1 shows an example of a Mach-Zehnder interferometer having a beam splitter and a beam combiner (Prior Art).

FIG. 2 illustrates an example embodiment of the invention comprising a Mach-Zehnder delay-line interferometer having two identical prisms, one prism functioning as a beam splitter and the other as a beam combiner.

FIG. 3 represents a top view of an example embodiment of the invention comprising two DQPSK delay-line interferometers having a beam splitting plate, two beam splitting prisms, a temperature compensator, and phase tuners.

FIG. 4 represents a side view of the example of a DQPSK delay-line interferometer from FIG. 3.

FIG. 5 is an example of a beam splitting plate for dividing the intensity of an input light signal into two equal-intensity output light signals having an intensity ratio between the two outputs of 50:50, that is, each output having half the intensity of the input.

FIG. 6 is an example of a spectrum of four separate outputs from the example embodiment of FIGS. 3-5.

FIG. 7 is a simplified representation of an example of a tuning mechanism with a movable prism and a fixed prism.

FIG. 8 is a partial pictorial view of an example of a micro tuner comprising a silicon plate and a thin film resistive heater.

FIG. 9 is a simplified top view of another example embodiment of the invention comprising two DQPSK delay-line interferometers using one beam splitting prism and one retro-reflector.

FIG. 10 is a simplified side view of the example of a DQPSK delay-line interferometer with a retro-reflective configuration of FIG. 9.

### DESCRIPTION

Some example embodiments of the invention comprise an optical delay-line interferometer related to a Mach-Zehnder interferometer. Optical delay-line interferometer embodiments of the invention are well suited for use in fiber-optic communication systems for decoding phase-encoded signals, for example signals encoded by Differential Phase Shift Keying (DPSK) or Differential Quadratic Phase Shift Keying (DQPSK). Embodiments of the invention may comprise more than one delay-line interferometer implemented with one beam splitting prism in some example embodiments and with two identical beam splitting prisms in alternative example embodiments. Each beam splitting prism may be a non-polarization beam splitting prism for splitting an incident light beam into two output light beams or for combining two incident light beams into one output light beam. Each delay-line interferometer may further include a beam splitting plate, a phase tuner, and a thermo-optic compensator.

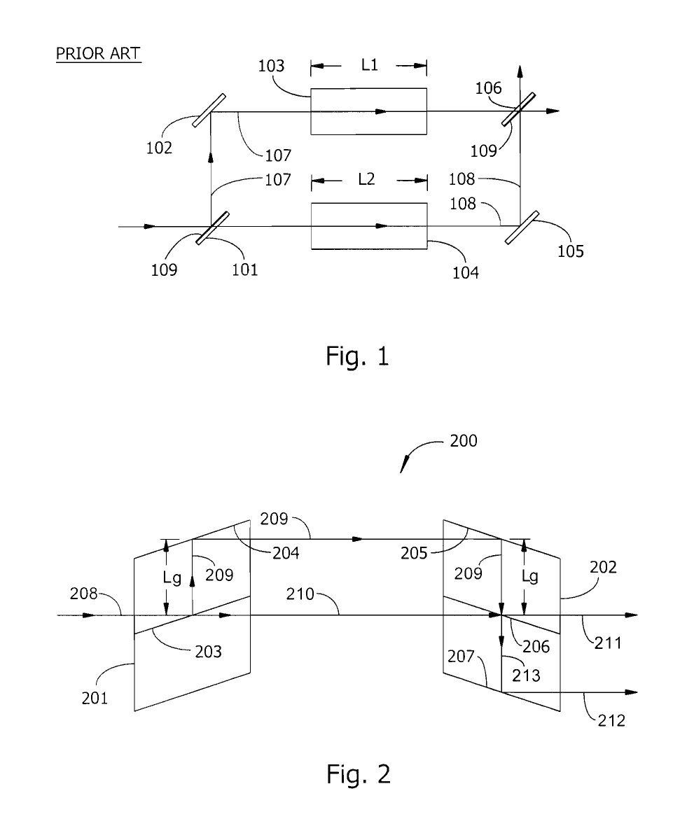

FIG. 1 illustrates an example of a Mach-Zehnder interferometer known in the art. The example of prior art in FIG. 1 includes two beam splitters (101, 106), each having a partially reflecting surface 109 through which some light incident on the surface is transmitted and some reflected, and two mirrors (102, 105) along two interferometer arms (107, 108). Light passing through each arm (107, 108) passes through optical media (103, 104). Light paths are indicated in FIG. 1 and in other figures herein by arrowheads on solid lines and generally represent the shortest path followed by light along each interferometer arm. Optical media 103 in the first arm 107 has refractive index n1. Optical media 104 in the second arm 108 has refractive index n2. A time delay between the two interference arms (107, 108) will be determined by the optical thickness difference, corresponding to (n1L1-n2L2), where L1 is a length measurement of a shortest path traversed by light passing through media 103, referred to herein as the thickness dimension of the media 103, and L2 is the corresponding thickness dimension through which light passes in media 104 in the second arm 108.

FIG. 2 shows an example of a delay-line interferometer embodiment of the invention 200, also referred to herein as an example interferometer. The example interferometer 200 of FIG. 2 includes a first non-polarization beam splitting prism 201 and a second non-polarization beam splitting prism 202 arranged as a Mach-Zehnder interferometer. The two beam splitting prisms are positioned relative to one another so that a transmitted light beam 210 and a reflected light beam 209 output from the first prism 201 are parallel and coplanar with each other and are also parallel and coplanar with a transmitted light beam 211 and a reflected light beam 212 output from the second prism 202. The example interferometer 200 includes a first 50:50 non-polarization beam splitting interface 203 and a second 50:50 non-polarization beam splitting interface 206, a first reflector 204, a second reflector 205, and a third reflector 207 implemented in a pair of identical prisms (201, 202). The first reflector 204, second reflector 205, and third reflector 207 may optionally be implemented as total-internal-reflection (TIR) surfaces. In the example illustrated in FIG. 2, the 50:50 non-polarization beam splitting interface (203, 206) in each prism is located between two TIR surfaces (e.g., 205, 207 in the second prism 202), with the beam splitting interfaces and TIR surfaces parallel to one another. The two beam splitting prisms (302, 303) are positioned relative to one another so that the first reflected light beam 209 and first transmitted light beam 210 after the beam splitting interface 203 in the first prism 201 are coplanar with a transmitted light beam at the first output port 211 and a second reflected light beam at the second output port 212 after the corresponding beam splitting interface 206 in the second prism 202.

Continuing with the example interferometer of FIG. 2, a light beam 208 incident to the first beam splitting prism 201 is divided into a first transmitted beam 210 and a first reflected beam 209 by the first beam splitting interface 203. The first transmitted beam 210 is directed to the second beam splitting interface 206 in the second prism 202. Part of the first transmitted beam 210 is transmitted through the second beam splitting interface 206 to a TIR surface 207 and contributes to a second transmitted beam directed to a first output port 211. Another part of the first transmitted beam 210 reflects from the second beam splitting interface 206 in the second prism 202 and contributes to a second reflected beam 213. The second transmitted beam 213 reflects from TIR surface 207 in the second prism 202 and is then directed to an output port 212.

The first reflected beam 209 is directed from the first beam splitting interface 203 toward the TIR surface 204 in the first prism 201. The first reflected beam 209 is then directed toward a TIR surface 205 in the second prism 202 and then toward the beam splitting interface 206 in the second prism. Part of the first reflected beam 209 passes through the beam splitting interface 206 and contributes to the second reflected beam 213. Another part of the first reflected beam 209 is reflected at the beam splitting interface 206 in the second prism 202 and contributes to light output from the first output port 211. Each of the two output ports (211, 212) therefore receives two beams coming from the two interferometer arms, one interferometer arm represented by the path followed by the first reflected beam 209 and the other arm represented by the path followed by the first transmitted beam 210.

With the configuration shown in FIG. 2, the light path difference between the two arms may be described as

D=2n_{g}L_{g}

where n_{g} is the refractive index of the prism material and L_{g} is the light path length in a prism between the beam splitting interface and the TIR surface, marked by “Lg” in each prism (201, 202) in the figure. The transmission of an output port is a sinusoidal function of frequency and may be represented by the expression

$$T = \frac{1}{2} \{ 1 + cos [ \frac{4 π {n}_{g}}{c} {vL}_{g} ] \}$$

where v is the optical frequency and c is the speed of light. The free spectral range (FSR) of this example interferometer 200 is

FSR=c/2n_{g}L_{g}

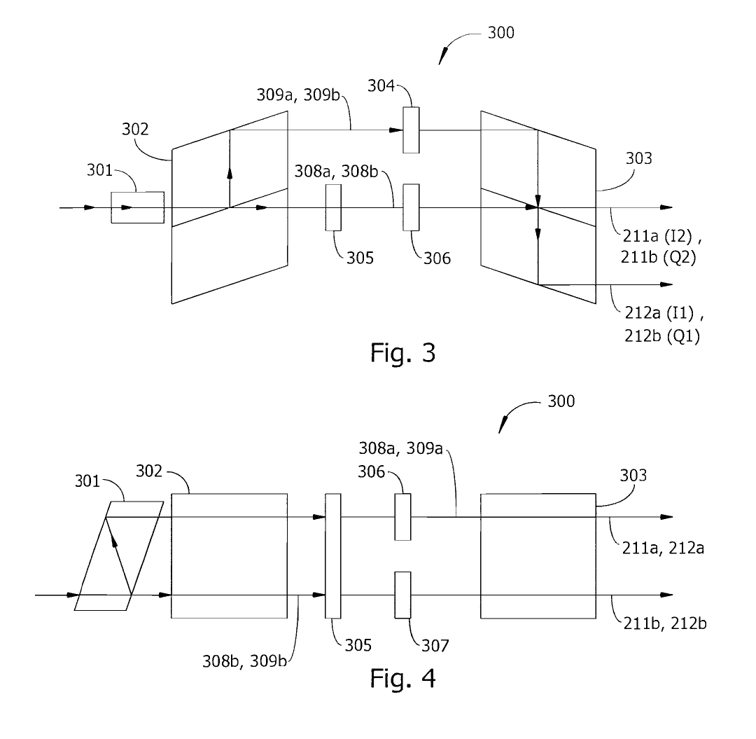

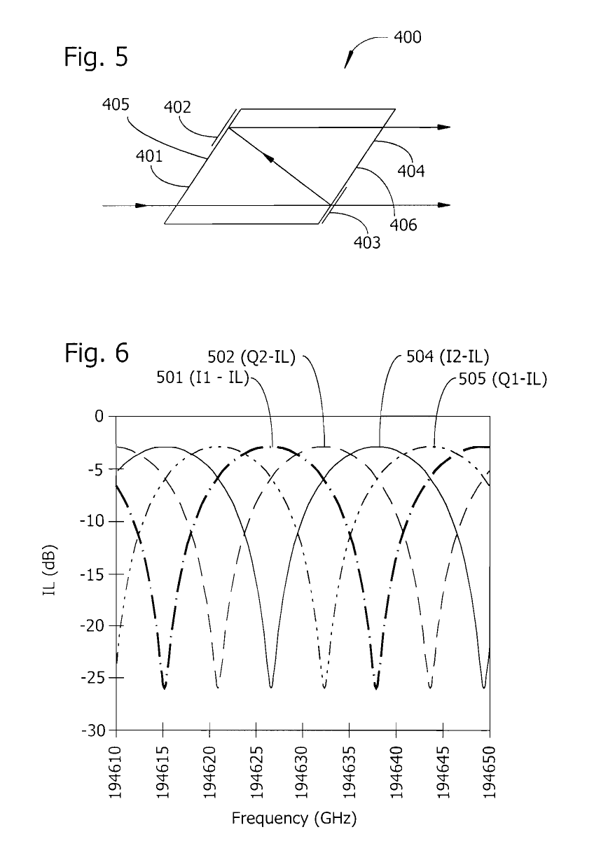

A DQPSK demodulator embodiment of the invention may include a pair of delay-line interferometers implemented with one pair of identical beam splitting prisms, as shown in FIGS. 3-4. Each of the beam splitting prisms (302, 303) in FIGS. 3-4 may optionally be beam splitting prisms as described for the example of FIG. 2. An example DQPSK demodulator embodiment 300 may include a 3 dB-coupler 301, also referred to as a beam splitting plate 301. A beam splitting plate suitable for use with an embodiment of the invention will be described later in relation to FIG. 5. A beam splitting plate divides an input light beam evenly into two equal-intensity output beams for forming two DPSK delay-line interferometers on parallel planes with a total of four output ports.

As shown in the example of FIGS. 3-4, a first delay-line interferometer (indicated by suffix “a” on reference designators) includes a short interferometer arm 308a, a long interferometer arm 309a, a first output port 211a, and a second output port 212a, all coplanar on a first common plane. A second delay-line interferometer (indicated by suffix “b” on reference designators) includes a short interferometer arm 308b, a long interferometer arm 309b, a first output port 211b, and a second output port 212b, all coplanar on a second common plane spatially separated from the first common plane for the first delay-line interferometer by the offset induced by the beam splitting plate 301. The spatial separation of the first and second common planes is suggested in FIG. 4, which shows the short and long arms (308a, 309a) for the first delay-line interferometer above the short and long arms (308b, 309b) for the second delay-line interferometer, and an example of a beam path through the beam splitting plate 301 for determining the separation between the two common planes. The beam splitting plate 301 therefore enables two delay-line interferometers to share two beam splitting prisms but having four non-overlapping, spatially separated output ports.

Although two DPSK delay-line interferometers may share the one pair of beam splitting prisms as suggested in FIGS. 3-4, the lengths of the light paths through each of the two interferometers may be slightly different due to the action of phase tuners in the light paths. By controlling the optical thickness of the phase tuners, the two DPSK delay-line interferometers may be set to different phases, for example one with a +45 degree phase angle and the other with a −45 degree phase angle. By way of example, the FSR of such a DQPSK demodulator may be about half of the transmission data rate.

The beam splitting plate may include two parallel surfaces for separating an input beam into two parallel output beams. As shown in the example of FIG. 5, each of the two parallel surfaces may be divided into two areas. A front surface 405 of an example embodiment of a beam splitting plate 400 is deposited with anti-reflection (AR) coating 401 in a first area and a high reflection coating 402 in an adjacent second area. In some example embodiments, a back surface 406 of the beam splitting plate 400 is deposited with 50% partial reflection coating 403 in a first area and AR coating 404 in an adjacent second area. In other example embodiments, the partial reflection coating reflects less than 50% of incident light. In yet other example embodiments, the partial reflection coating reflects more than 50% of incident light.

An example of an output spectrum for an example DQPSK delay-line interferometer is shown in FIG. 5. Peak frequencies 501, 502, 503 and 504 in four output ports, which may be referred to as ports I1, I2, Q1 and Q2, are spaced FSR/4 apart. Light from each of four output ports may be coupled to two pairs of balanced detectors for decoding input signals.

Because the refractive index of glass is temperature dependent, the transmission peak frequency for an interferometer embodiment of the invention changes when the ambient temperature changes. A phase compensator, for example a compensation plate, may optionally be included in one of the arms of an example interferometer embodiment of the invention to compensate for temperature effects. For example, when a beam splitting prism is made of fused silica glass, silicon will be a suitable material for a compensator. FIGS. 3-4 show an example of a DQPSK delay line interferometer embodiment of the invention with a peak transmission tuner implemented as a thermo-optic compensator. The temperature-compensated example interferometer of FIGS. 3-4 may take advantage of the much larger thermo-optic coefficient for silicon compared to the thermo-optic coefficient for fused silica by optionally including a thin layer of silicon 305 in the shorter interferometer arm 308. The temperature dependence of the refractive index of silicon is used in some embodiments of the invention to make an interferometer that is tunable through temperature control. A resistance heater attached to the each of the silicon plates (304, 306) can slightly change the light path difference, thereby tuning the transmission peak frequency. The silicon plates (304, 306) may therefor also be referred to herein as phase tuners. Phase tuners may optionally be made adjustable as will be explained for the example of FIG. 8.

A push-and-pull mechanism is shown in the example of FIGS. 3-4. A first silicon plate 304 may be used for push tuning. Push tuning refers to moving a transmission peak for an interferometer embodiment of the invention to a longer wavelength when the temperature of the silicon plate is increased. When the temperature of the first silicon plate 306 increases, the transmission peak wavelength of the example DQPSK interferometer embodiment of the invention moves to longer wavelengths. A second silicon plate 306 may be used to implement pull tuning, that is, increasing the temperature of the second silicon plate 306 decreases the transmission peak wavelength of the example interferometer.

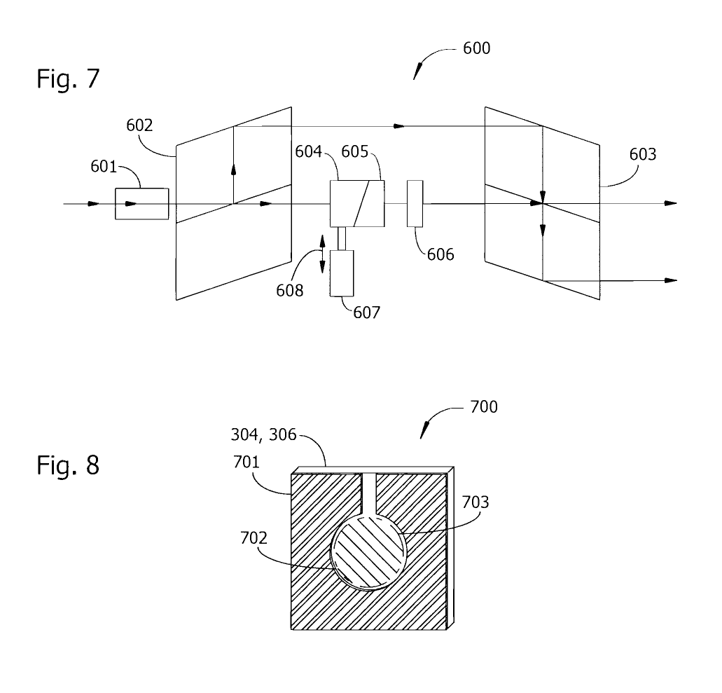

Tuning of an example interferometer may be accomplished by applying the thermo-optic effect, i.e., changing an optical path length by heating an optical element. Tuning by the thermo-optic effect may require a significant amount of electrical power and may require about one second to accomplish a change in tuning. For some applications, completion of tuning within a few milliseconds may be preferred. An electro-mechanical peak transmission tuner may be used by some embodiments of the invention in order to complete a change in tuning in a time duration of a few milliseconds or less. An example embodiment 600 of an interferometer having an electro-mechanical peak transmission tuner and thermal compensation is shown in FIG. 7. In the example interferometer 600 of FIG. 7, a movable prism 604 and a fixed prism 605 are inserted into one of the two interferometer arms between a first beam splitting prism 602 and a second beam splitting prism 603. The first and second beam splitting prisms may be as described for the example of FIG. 2. A beam splitting plate 601 in the example embodiment of FIG. 7 corresponds to the beam splitting plate 301 previously described for the example embodiment of FIGS. 3-4. The movable prism 604 may optionally be moved by a piezoelectric actuator 607 or similar electro-mechanical actuator. The piezoelectric actuator 607 controllably displaces the movable prism 604 relative to the fixed prism 605 in the directions suggested by a double-headed arrow 608 in FIG. 7. Because of the rapid response speed of piezoelectric actuators, the optical path length can be changed within a few milliseconds, correspondingly changing the transmission peak frequency from an old value to a new value (i.e., tuning the transmission peak frequency). A thermal compensation plate 606 may optionally be included to compensate for thermal effects on the beam splitting prisms (602, 603).

The time duration required to perform tuning may be reduced by reducing the thermal mass of the silicon plate (e.g., 304, 306 in FIGS. 3-4) and of a heater used to increase the temperature of the plate. FIG. 8 shows an example of a thermo-optic peak transmission tuner, also referred to as a phase tuner or as a micro tuner, having a low-thermal-mass silicon plate and heater. The example of a peak transmission tuner 700 of FIG. 8 includes a layer of electrical resistor material 701 in contact with a silicon substrate, for example by depositing the electrical resistor material onto the substrate. The substrate corresponds to the examples of phase tuners comprising silicon plates (304, 306) in FIGS. 3-4. An aperture 702 may be formed in the layer of electrical resistor material 701. The aperture 702 has a diameter sufficient to permit light on the interferometer arm to pass unobstructed through the layer of electrical resistor material. An anti-reflection coating 703 may optionally be applied to the substrate (304, 306) within the aperture 702 to reduce reflection losses and local cavity effects. An electric current may be passed through the electrical resistor material 701 to raise, or alternatively to hold, the temperature of the silicon substrate at a selected temperature, thereby causing a corresponding change in the index of refraction of the substrate and changing the phase of a light signal passing through the substrate.

When the silicon plate (304, 306) is inserted into the light path of the delay-line interferometer, the phase shift is dependent on the temperature because the thickness and refractive index of the silicon plate are both temperature dependent. Using a selected value for FSR, the thickness of a silicon plate for a temperature-compensated embodiment of the invention may be determined from the following equations:

2n_{g}L_{g}−(nₛ−1)Lₛ=c/FSR

L_{g}(∂n_{g}/∂T)ΔT+n_{g}(∂L_{g}/∂T)ΔT=Lₛ(∂nₛ/∂T)ΔT+nₛ(∂Lₛ/∂T)ΔT

where nₛ and Lₛ are the silicon plate's refractive index and thickness.

Interferometer performance preferably remains the same for all polarization states. However, at an incident angle of about 45 degrees, the beam splitting coating for a beam splitting prism is polarization dependent in both phase shift and beam splitting ratio. For the two orthogonal “p” and “s” polarization components of light, the slight difference in splitting ratio and phase shift may affect the interferometer's extinction ratio and polarization dependent loss. A polarization-independent beam splitting prism may therefore be preferred. To decrease polarization dependence, a specially designed coating formula may be applied. Alternatively, waveplates may be included in each of the two arms of an interferometer embodiment of the invention. Phase differences created by the waveplates compensate for polarization dependence in the beam splitting coating.

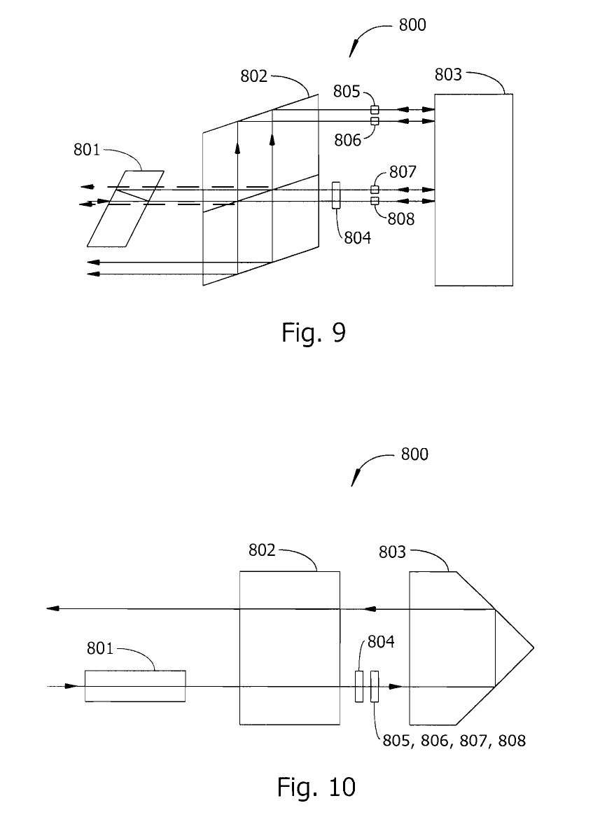

Another example embodiment 800 of a delay-line interferometer is shown in FIGS. 9-10. In the illustrated example embodiment, a retro-reflective prism 803 is employed to fold the light path. The retro-reflective prism has a 90 degree roof angle for producing a reflected light beam that is parallel with an incident light beam. In this example embodiment, only one beam splitting prism 802 is used, and the two DPSK delay-line interferometers are spatially separated in the horizontal direction by a beam splitting plate 801. A thermal compensation plate 804, corresponding to the example thermal compensation plate 305 in FIGS. 3-4, may optionally be positioned between the beam splitting prism 802 and retro-reflective prism 803 as shown in the example of FIG. 9. FIG. 8 further shows examples of phase tuners (805, 806, 806, 808) positioned between the beam splitting prism 802 and retro-reflective prism 803. Phase tuners in the example of FIG. 8 correspond to the example phase tuners (304, 306) in FIGS. 3-4 and optionally correspond to the phase tuner example of FIG. 8.

The present disclosure is to be taken as illustrative rather than as limiting the scope, nature, or spirit of the subject matter claimed below. Unless expressly stated otherwise herein, ordinary terms have their corresponding ordinary meanings within the respective contexts of their presentations, and ordinary terms of art have their corresponding regular meanings.

What is claimed is:

1. An interferometer for fiber optic communication systems, comprising:
a beam splitting prism comprising:
a first total-internal-reflection surface,
a second total-internal-reflection surface parallel to said first total-internal-reflection surface; and
a beam splitting interface parallel to said first total-internal-reflection surface;
a second of said beam splitting prism; and
a thermo-optic compensator disposed between said first and second beam splitting prisms.

2. The interferometer of claim 1, wherein said beam splitting prism and said second beam splitting prism are positioned relative to one another so that a transmitted light beam and a reflected light beam output from said beam splitting prism are parallel and coplanar with each other and are parallel and coplanar with a transmitted light beam and a reflected light beam output from said second beam splitting prism.

3. The interferometer of claim 1, wherein said beam splitting interface in said beam splitting prism and said beam splitting interface in said second beam splitting prism are 50:50 non-polarization beam splitting interfaces.

4. The interferometer of claim 1, wherein said second total-internal-reflection surface in said beam splitting prism is parallel to said first total-internal-reflection surface.

5. The interferometer of claim 1, further comprising a fixed tuning prism and a movable tuning prism disposed between said first and second beam splitting prisms.

6. The interferometer of claim 1, further comprising a phase compensation plate disposed between said beam splitting prism and said second beam splitting prism.

7. The interferometer of claim 1, wherein said thermo-optic compensator comprises:
a silicon plate;
a layer of electrical resistor material on said silicon plate, wherein said layer of electrical resistor material is formed with an aperture; and
an anti-reflection coating applied to said silicon plate within said aperture formed in said layer of electrical resistor material.

8. The interferometer of claim 1, further comprising a second thermo-optic compensator disposed between said beam splitting prism and said second beam splitting prism.

9. The interferometer of claim 1, further comprising a beam splitting plate for dividing an input light beam into two equal-intensity output light beams spatially separated from one another.

10. The interferometer of claim 9, wherein said beam splitting plate comprises:
a front surface;
a back surface;
an anti-reflection coating on said front surface;
a high-reflection coating on said front surface adjacent to said anti-reflection coating;
a partial reflection coating on said back surface; and
an anti-reflection coating on said front surface adjacent to said partial reflection coating.

11. The interferometer of claim 10, wherein said partial reflection coating reflects fifty percent (50%) of incident light.

12. The interferometer of claim 10, wherein said partial reflection coating reflects less than fifty percent (50%) of incident light.

13. The interferometer of claim 10, wherein said partial reflection coating reflects more than fifty percent (50%) of incident light.

14. An interferometer for fiber optic communication systems, comprising:
a beam splitting prism comprising:
a first total-internal-reflection surface,
a second total-internal-reflection surface parallel to said first total-internal-reflection surface; and
a beam splitting interface parallel to said first total-internal-reflection surface;
a retro-reflective prism; and
a beam splitting plate.

15. The interferometer of claim 14, wherein said beam splitting interface in said beam splitting prism is a 50:50 non-polarization beam splitting interfaces.

16. The interferometer of claim 14, wherein said second total-internal-reflection surface in said beam splitting prism is parallel to said first total-internal-reflection surface.

17. The interferometer of claim 14, wherein said beam splitting interface in said beam splitting prism is a 50:50 non-polarization beam splitting interface.

18. The interferometer of claim 14, wherein said second total-internal-reflection surface in said beam splitting prism is parallel to said first total-internal-reflection surface.

19. The interferometer of claim 14, further comprising at least two phase tuners disposed between said beam splitting prism and said retro-reflective prism.

20. The interferometer of claim 14, further comprising a thermal compensation plate disposed between said beam splitting prism and said retro-reflective prism.
